(19) United States
(12) Patent Application Publication
(10) Pub. No.: US 2026/0225672 A1
(43) Pub. Date: Aug. 6, 2026

(54) MULTI-IMPLEMENT AGRICULTURAL VEHICLE

(71) Applicant: ORCHARD MACHINERY CORPORATION, Yuba City, CA (US)

(72) Inventors: Alan Cooper Isaacson, Woodland, CA (US); Brian Andersen, Yuba City, CA (US)

(73) Assignee: ORCHARD MACHINERY CORPORATION, Yuba City, CA (US)

(21) Appl. No.: 19/531,117

(22) Filed: Feb. 5, 2026

Related U.S. Application Data
(60) Provisional application No. 63/754,503, filed on Feb. 5, 2025.

(51) Int. Cl. B62D 49/06

(52) U.S. Cl. CPC B62D 49/065

(57) ABSTRACT

A multi-use agricultural vehicle includes a modular interface system configured to selectively couple multiple agricultural implements. The interface system provides structural alignment, mechanical fastening, and a hydraulic connection assembly, enabling a single vehicle platform to perform harvest and non-harvest agricultural operations.

### CROSS-REFERENCE TO RELATED APPLICATIONS

This application claims priority to and the benefit of U.S. Provisional Patent Application No. 63/754,503 filed on Feb. 5, 2025, entitled “Multi-Implement Agricultural Vehicle,” the entire contents of which are incorporated herein by reference.

### FIELD OF INVENTION

The present disclosure relates generally to agricultural vehicles and, more particularly, to a multi-use agricultural vehicle having a modular interface system enabling selective attachment and powered operation of multiple agricultural implements.

### BACKGROUND

The subject disclosure relates to agricultural vehicles and, more particularly, a multi-implement harvest vehicle and tractor and a systemic interface for enabling the same.

Harvesting crops typically requires the use of different vehicle types, each type of vehicle having a specific, limited purpose. Such single-purpose vehicles are typically limited to one portion overall harvesting process, and so may sit idle for most of the harvest processes, only being used “seasonally,” such as only during the harvest season. For instance, a dedicated vehicle, known generically as a “shuttle,” would transport product during harvest; after harvesting it would sit idle. Vehicles used may include harvest shuttles, bin carriers, tugs, tractors, and/or discharge vehicles. Each such vehicle is typically designed for a limited purpose, and is therefore idle for significant portions of the year.

A “PTO implement” refers to a piece of machinery, like a tiller, that is powered by a tractor's “Power Take-Off” (PTO) system, essentially using the tractor's engine power to operate the attached implement through a rotating shaft connection, allowing it to perform various tasks like tilling soil without its own engine. However, in the tree harvesting industry, there are many implements that will not interface with a standard PTO system of a standard tractor. These systems are often incompatible with orchard-specific implements such as bin carriers, rear discharges, or side dumpers, which may require non-standard mechanical integration, structural load transfer, or specialized hydraulic and control interfaces.

As a result, growers frequently maintain separate fleets: dedicated harvest shuttles for seasonal use and tractors for non-harvest operations. This duplication increases capital costs, maintenance burdens, labor requirements, and equipment underutilization.

Accordingly, there is a need for a single agricultural vehicle platform capable of selectively functioning as a harvest vehicle and as a tractor or material handling vehicle, enabled by a systemic interface that allows rapid, secure, and functional integration of multiple implements having differing operational requirements. As can be seen, there is a need for multi-implemented agricultural vehicle and tractor and a systemic interface for enabling the same, whereby the resulting multi-use agricultural vehicle can be productively used year-round as opposed to only seasonally.

These and other features, aspects and advantages of the subject disclosure will become better understood with reference to the following drawings, description and claims.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In one aspect, the invention provides a multi-use agricultural vehicle comprising a powered chassis and a modular interface system configured to operatively associate with and enable implements which include the following: a bin carrier, a tug, a rear discharge, and a side dump.

In another aspect, the interface system provides structural alignment, mechanical fastening, electrical connectivity, and control communication between the vehicle and each coupled implement.

In yet another aspect, the interface system further provides a hydraulic connection assembly configured to provide hydraulic power and fluid communication to agricultural implements such as, but not limited to, a bin carrier, a tug, a rear discharge, and a side dump.

In an embodiment of the invention, the interface system enables selective operation of one or more implements (a bin carrier, a tug, a rear discharge, and/or a side dump) using a single vehicle platform.

In another aspect, the vehicle is operable in a manned mode or an autonomous mode.

The invention thereby enables year-round utilization of a single vehicle platform, reducing equipment redundancy, lowering operational costs, and improving return on investment.

These and other aspects, embodiments, features, and advantages of the invention will become better understood with regard to the following description, appended claims and any accompanying drawings.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1A is a top plan view of an exemplary embodiment of the subject disclosure attached to a vehicle.

FIG. 1B is a top perspective view of an exemplary embodiment of the subject disclosure attached to the vehicle of FIG. 1A.

FIG. 1C is a front elevation view of an exemplary embodiment of the subject disclosure attached to the vehicle of FIG. 1A.

FIG. 1D is a side elevation view of an exemplary embodiment of the subject disclosure attached to the vehicle of FIG. 1A.

FIG. 2A is a top plan view of an exemplary embodiment of the subject disclosure operatively associated with a bin carrier.

FIG. 2B is a top perspective view of an exemplary embodiment of the subject disclosure operatively associated with the bin carrier.

FIG. 2C is a front elevation view of an exemplary embodiment of the subject disclosure operatively associated with the bin carrier.

FIG. 2D is a side elevation view of an exemplary embodiment of the subject disclosure operatively associated with the bin carrier.

FIG. 3A is a top plan view of an exemplary embodiment of the subject disclosure operatively associated with a tug.

FIG. 3B is a top perspective view of an exemplary embodiment of the subject operatively associated with the tug.

FIG. 3C is a front elevation view of an exemplary embodiment of the subject disclosure operatively associated with the tug.

FIG. 3D is a side elevation view of an exemplary embodiment of the subject disclosure operatively associated with the tug.

FIG. 4A is a top plan view of an exemplary embodiment of the subject disclosure operatively associated with a rear discharge.

FIG. 4B is a top perspective view of an exemplary embodiment of the subject disclosure operatively associated with the rear discharge.

FIG. 4C is a front elevation view of an exemplary embodiment of the subject disclosure operatively associated with the rear discharge.

FIG. 4D is a side elevation view of an exemplary embodiment of the subject disclosure operatively associated with the rear discharge.

FIG. 5A is a top plan view of an exemplary embodiment of the subject disclosure operatively associated with a side dump.

FIG. 5B is a top perspective view of an exemplary embodiment of the subject disclosure operatively associated with the side dump.

FIG. 5C is a front elevation view of an exemplary embodiment of the subject disclosure operatively associated with the side dump.

FIG. 5D is a side elevation view of an exemplary embodiment of the subject disclosure operatively associated with the side dump.

FIG. 6 is an elevation view of an exemplary embodiment of the subject disclosure.

FIG. 7 is a detailed elevation view of an exemplary embodiment of the subject disclosure.

FIG. 8 is a perspective view of an exemplary embodiment of the subject disclosure operatively associated with the tug.

FIG. 9 is a detailed perspective view of FIG. 8.

FIG. 10 is a perspective view of an exemplary embodiment of the subject disclosure operatively associated with the rear discharge.

FIG. 11 is a detailed perspective view of the subject disclosure in FIG. 10.

The exemplification set out herein illustrates an embodiment of the invention, and such exemplification is not to be construed as limiting the scope of the invention in any manner.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The subject matter of aspects of embodiments of the present invention is described with specificity herein to meet statutory requirements. However, the description itself is not intended to limit the scope of any patent issuing from this description. Rather, the inventors have contemplated that the claimed subject matter might also be embodied in other ways, to include different elements or combinations of elements similar to the ones described in this document, in conjunction with other present or future technologies.

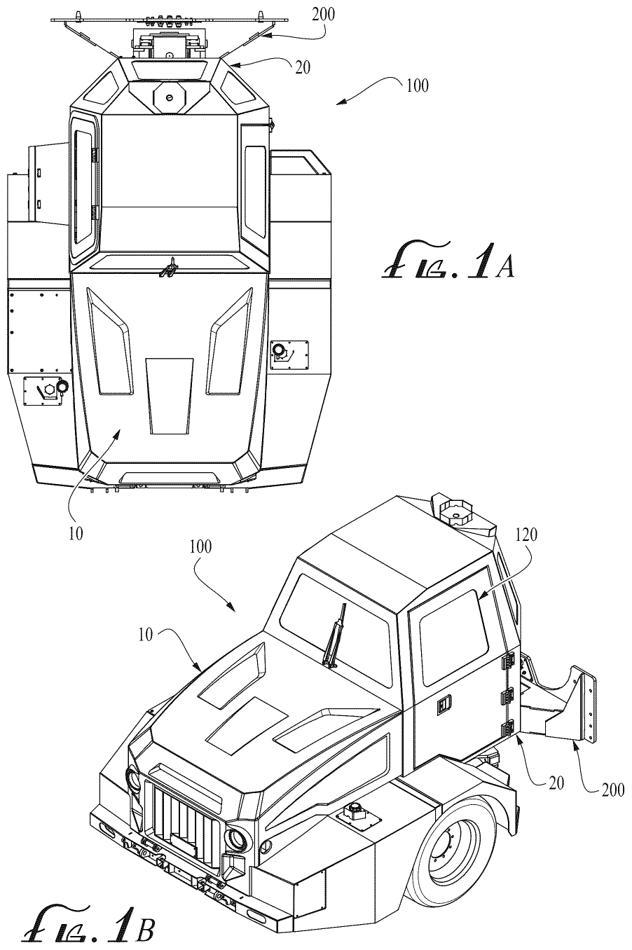

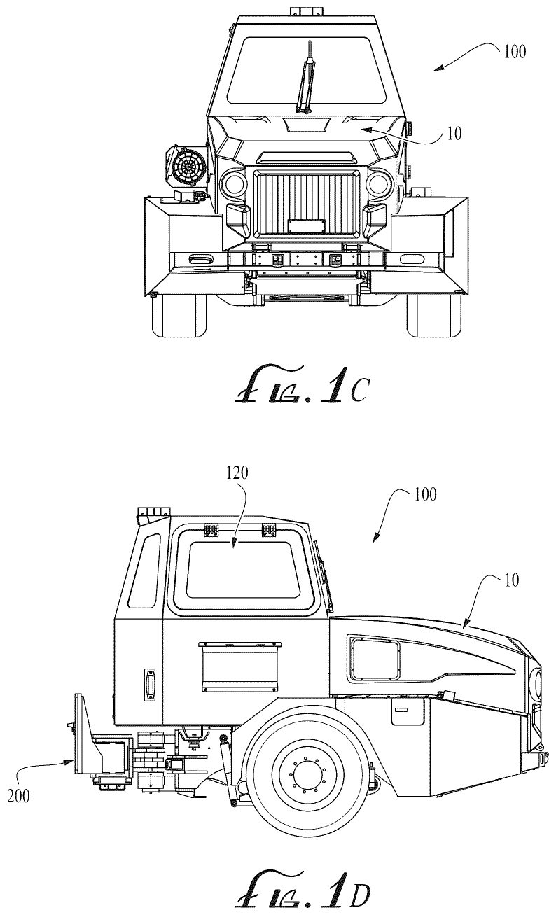

Referring now to FIGS. 1A through 5D, the subject disclosure may include an agricultural vehicle 100 (such as an AR-500) that has a chassis which acts as the foundation of the machine and encloses a drive engine. The chassis includes a front half 10 known as the power unit and houses the engine, hydraulics, electronics and operator. A rear half 20 of the chassis is connected to a hitch interface system 200 which allows a tote 210a, 210b, 210c (generic term for a harvest implement) or a tug 220 (generic term for a tractor three point and PTO implement) to be attached and become an integrated part of the propulsion system of the vehicle while providing for specific mission critical features during both harvest and non-harvest operations.

The vehicle is used during harvest to transport nut products from deep in an orchard to the perimeter where it is prepped for transport. There are multiple different options (totes) which can be selected based on product needs. During non-harvest time, the vehicle is easily transformed into a tractor complete with a three-point hitch and/or power take off. Operation of the machine can be done with a driver in the seat of the cab (the front half 10), or autonomously through a vision-based autonomy stack option. The new features of the invention are the multiple implement options that can easily be coupled through an interface with the operation of said machine autonomously if so desired.

General Description of the Vehicle Architecture

Referring generally to FIGS. 1A-1D , a multi-use agricultural vehicle 100 includes a chassis comprising a front power unit 10 and a rear interface region 20.

The front power unit 10 houses:
(a) an internal combustion engine or other power source;
(b) hydraulic pumps;
(c) electronic control units;
(d) operator controls; and
(e) optionally, a cab 120 for a human operator.

The rear interface region 20 is configured to receive an interface system 200, which allows selective attachment of one of several agricultural implements.

### Exemplary Embodiment of the Interface System

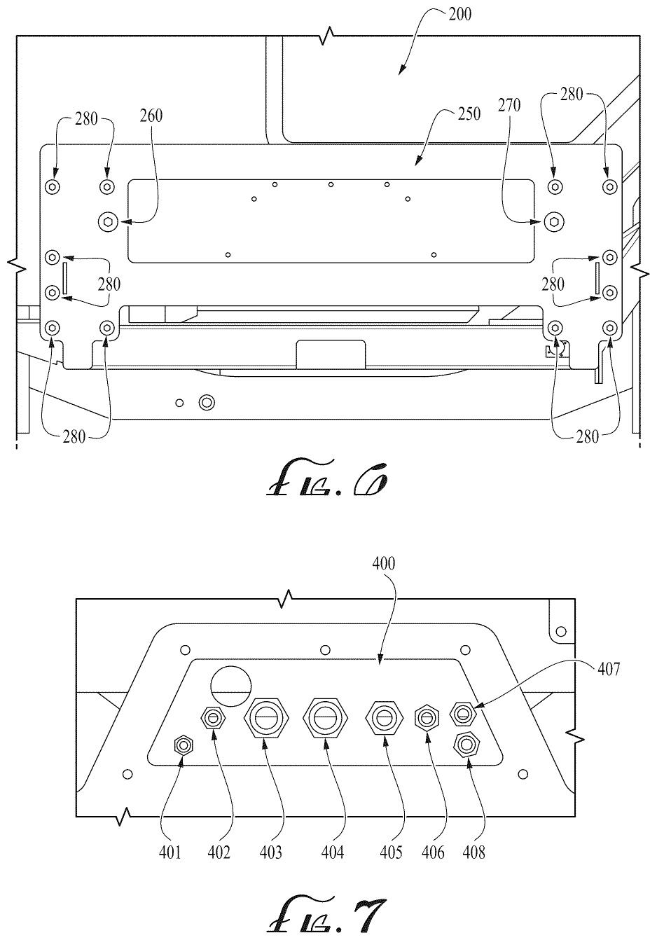

Referring to FIGS. 6-7 , an exemplary embodiment of the interface system 200 includes the following:
1. Structural Frame 250—A rigid structural frame configured to transmit vertical loads, longitudinal forces, and torsional forces between the vehicle and an attached implement.
2. Alignment Features 260, 270—One or more alignment features, such as alignment pins positioned on opposing lateral sides of the interface system, configured to guide an implement into a predetermined mounted position relative to the vehicle.
3. Fastener Array 280—A plurality of mechanical fasteners, in one non-limiting exemplary embodiment, the fastener array comprises twelve fasteners, which are configured to rigidly secure the implement to the vehicle after alignment.
4. Electrical Interface 300a, 300b—An electrical connector configured to provide electrical power, control signals, and data communication between the vehicle and the attached implement.
5. Hydraulic Connection Assembly 400-A hydraulic connection assembly configured to hydraulically couple the vehicle to any of the selectable implements, including but not limited to, a bin carrier a tug, a rear discharge, and a side dump. In an exemplary embodiment, the hydraulic connection assembly may include a hydraulic manifold having multiple ports, including but not limited to: (a) a hi/low valve port 401; (b) a load sense port 402; (c) a pressure port 403; (d) a return manifold 404; (e) a wheel motor case drain port 405; (f) a traction valve tee 406; and (g) wheel motor A and B ports (407, 408, respectively).

The hydraulic connection assembly may selectively route hydraulic power based on the type of implement coupled to the interface system.

### Implements

The interface system 200 is configured to operatively associate with multiple different implements, including, but not limited to, the following exemplary embodiments:

### (a) Bin Carrier

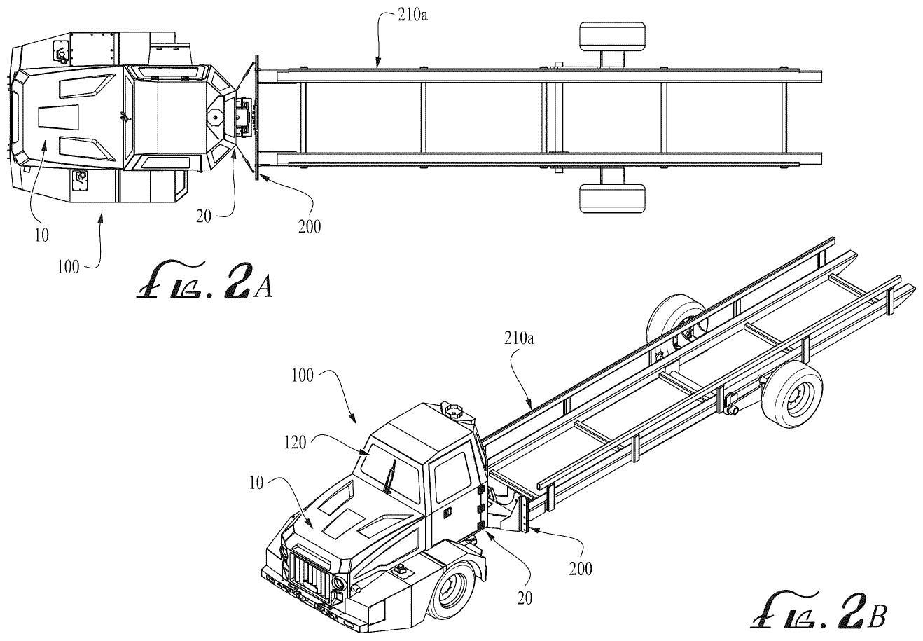

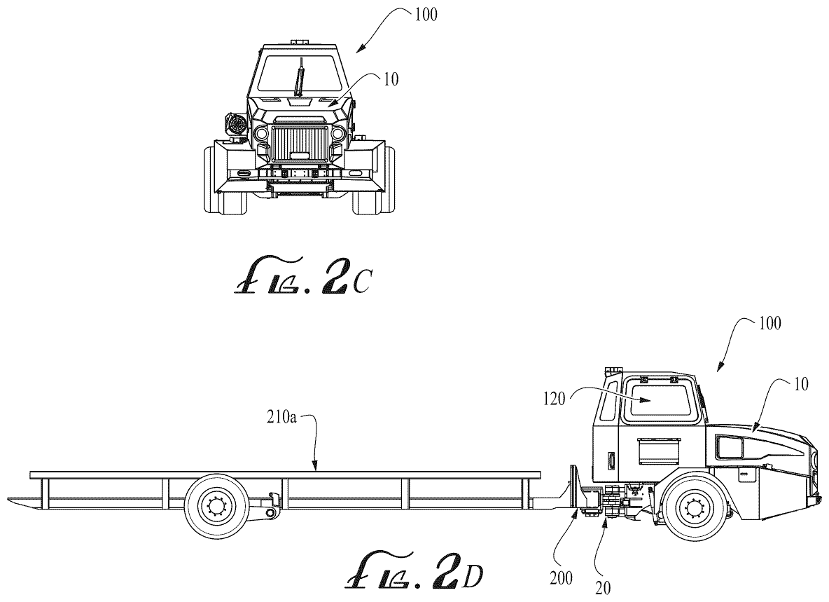

Referring to FIGS. 2A-2D, a bin carrier 210a is configured for transporting harvested agricultural product from within an orchard to a collection or staging area. The bin carrier 210a is mechanically and electrically coupled to the vehicle through the interface system 200.

### (b) Tug

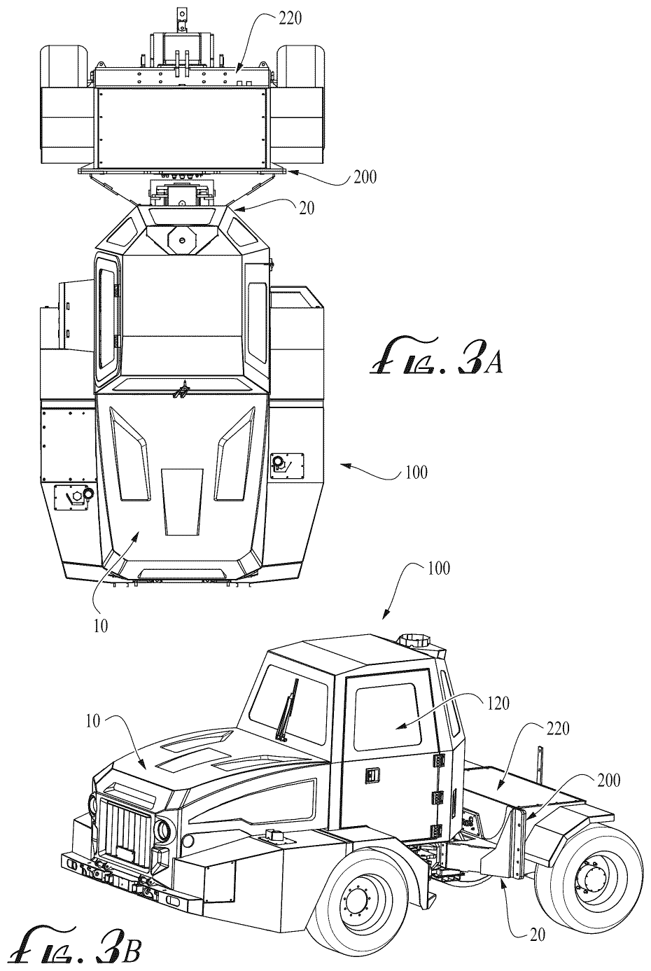

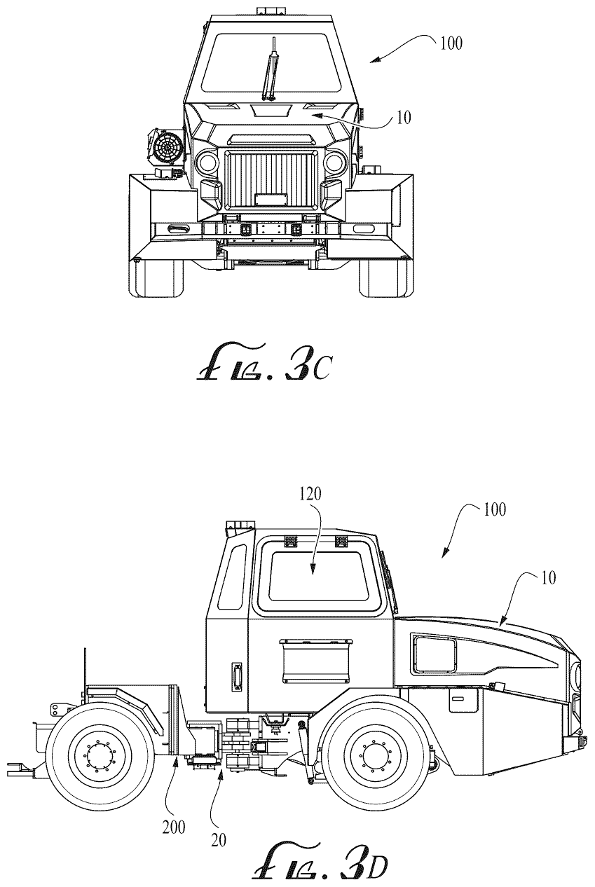

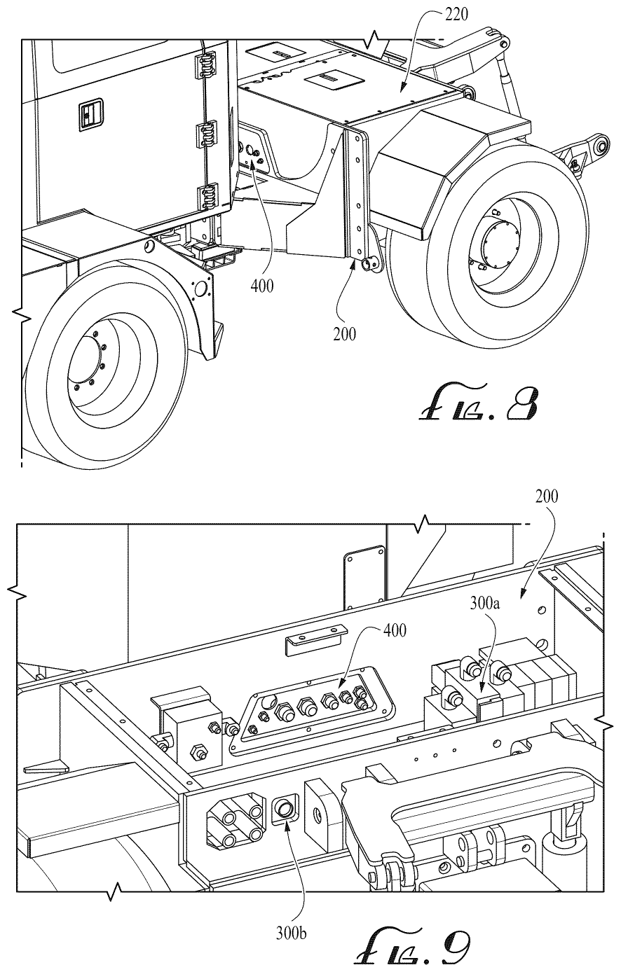

Referring to FIGS. 3A-3D and FIGS. 8-9, a tug 220 implement provides tractor-like functionality, including a three-point hitch and PTO capability, enabling operation of standard agricultural implements during non-harvest operations.

### (c) Rear Discharge

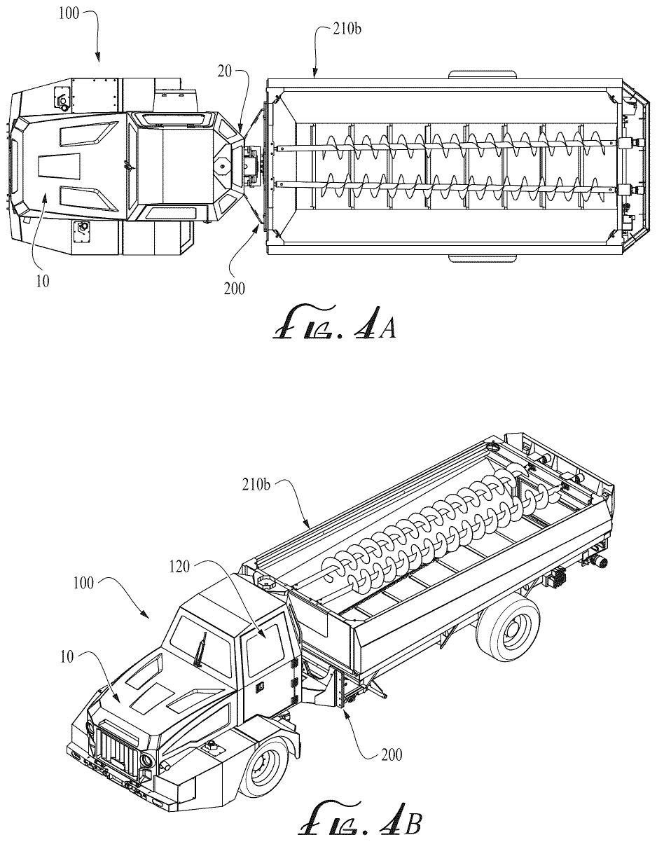

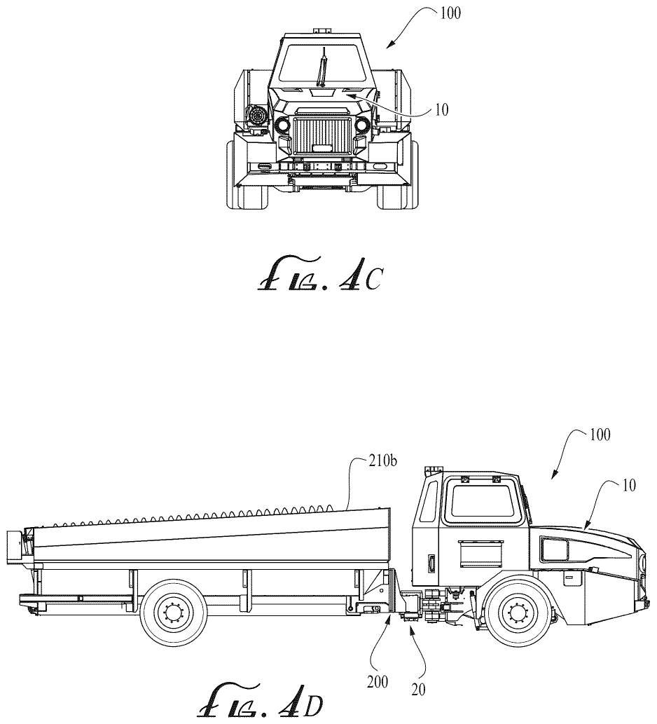

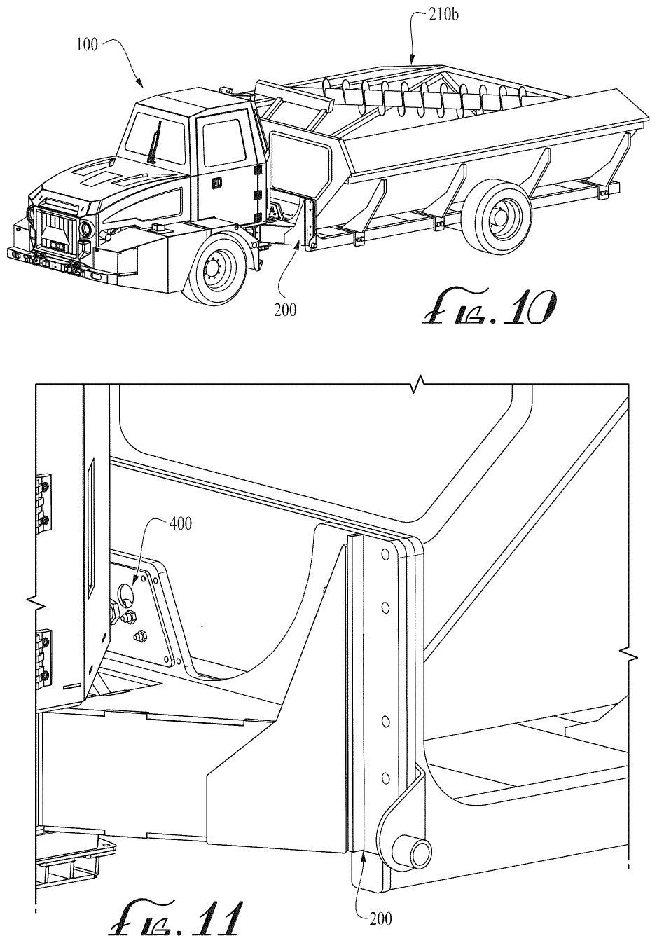

Referring to FIGS. 4A-4D and FIGS. 10-11, a rear discharge 210b is configured to discharge material rearwardly from the vehicle and is mechanically integrated via the interface system 200.

### (d) Side Dump

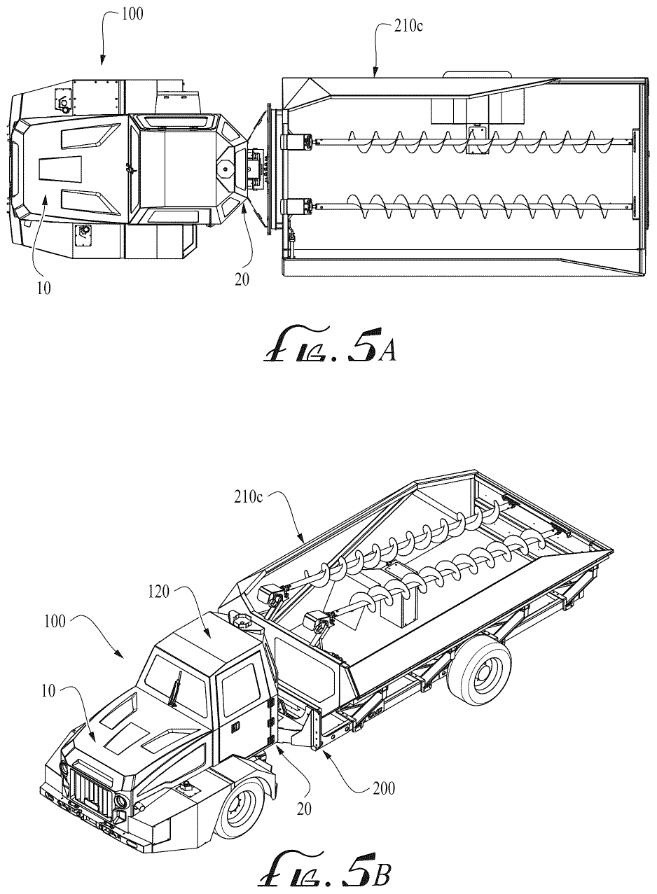

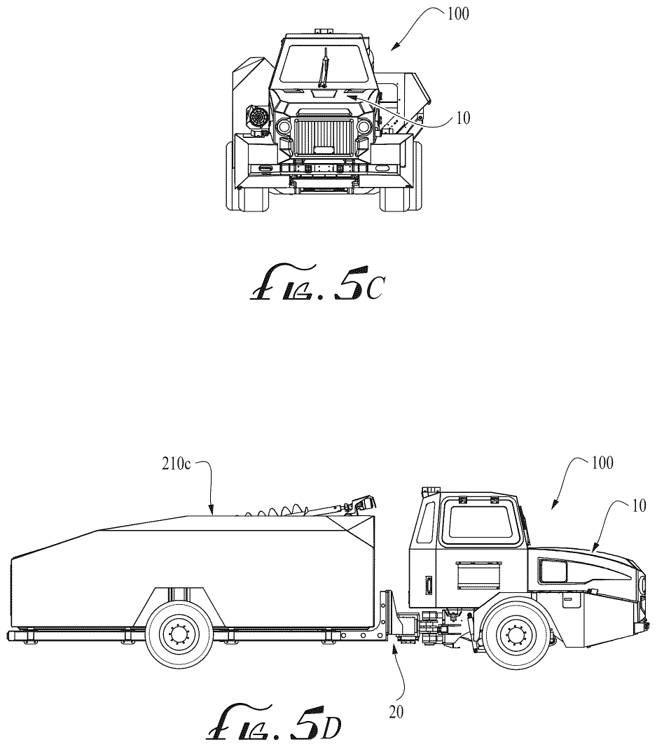

Referring to FIGS. 5A-5D, a side dump 210c is configured to laterally discharge material.

Each implement may receive hydraulic power, electrical power, and control signals through the interface system 200.

### Retrofit System

In one or more exemplary embodiments, the modular interface system 200 described herein may be provided as part of a retrofit system or retrofit kit configured to convert an existing agricultural vehicle into a multi-implement agricultural vehicle. The retrofit system includes the modular interface system 200 and is configured to be mounted to a rear portion of an agricultural vehicle that was not originally designed or manufactured for multi-implement operation. In such embodiments, the retrofit system enables the existing agricultural vehicle to selectively couple and operate multiple different agricultural implements such as those disclosed herein (e.g., a tug, a rear discharge, a bin carrier, and/or a side dump).

The retrofit system may include one or more of the following components: (1) a structural mounting frame 250 configured to attach to an existing vehicle chassis or frame; (2) alignment features 260, 270 configured to position an agricultural implement relative to the vehicle; (3) a plurality of mechanical fasteners 280 configured to secure the retrofit system and the implement to the vehicle; (4) an electrical interface 300a, 300b configured to electrically connect the retrofit system to an existing vehicle electrical system; and, (5) a hydraulic connection assembly 400 configured to connect to an existing hydraulic system of the vehicle and to provide hydraulic power to a plurality of different agricultural implements.

In one embodiment, the retrofit system includes adapter brackets, mounting plates, or structural reinforcement members configured to interface with non-standard or legacy vehicle frames. In another embodiment, the retrofit system is configured to integrate with existing hydraulic pumps, electronic control units, and operator controls of the vehicle, such as that shown in FIG. 9.

The retrofit system may further include control logic or electronic modules configured to enable the vehicle to recognize a coupled implement and selectively route hydraulic power, electrical power, and control signals based on the implement type.

In certain embodiments, the retrofit system enables an existing agricultural vehicle to operate in both harvest and non-harvest modes, thereby converting a seasonally used vehicle into a year-round, multi-purpose agricultural machine.

The retrofit system may be installed as an aftermarket upgrade, factory-installed option, or dealer-installed conversion, without requiring substantial modification to the core vehicle drivetrain or power unit.

### Modes of Operation

The multi-use agricultural vehicle described herein can be configured to operate in multiple modes of operation, depending on the operational requirements, environmental conditions, and configuration of the vehicle and attached implement.

The vehicle may be operated by a human operator positioned in the cab 120, or autonomously such as by using a vision-based autonomy stack and electronic control system. The interface system supports both modes of operation without modification.

In a manned mode of operation, the vehicle is controlled by a human operator positioned within a cab or operator station of the front power unit. Operator inputs may be provided through one or more control interfaces, including a steering wheel, joystick, pedals, touchscreen displays, or other human-machine interfaces. In this mode, the operator may manually select an attached implement and control propulsion, steering, braking, hydraulic functions, electrical functions, and implement-specific operations. The modular interface system enables the operator to control different implements using a unified control architecture, regardless of whether the attached implement is a bin carrier, tug, rear discharge, or side dump.

In a semi-autonomous mode of operation, the vehicle performs one or more operational functions automatically while remaining under supervision of a human operator. For example, the vehicle may autonomously maintain a predetermined speed, heading, or path within an orchard row, while the operator supervises implement operation or intervenes as needed.

In another embodiment, a semi-autonomous mode includes automated control of implement-specific functions, such as dumping, lifting, or material discharge, while the operator retains control over navigation or safety-critical functions. The modular interface system allows control signals to be selectively routed to the attached implement based on the selected mode of operation

In yet another exemplary embodiment, in a fully autonomous mode of operation, the vehicle is configured to operate without direct human control. In this mode, the vehicle may utilize one or more sensors, including cameras, Lidar, radar, GPS, or other perception systems, in combination with a vision-based autonomy stack and onboard control logic. The vehicle may autonomously navigate through an agricultural environment, detect obstacles, follow predefined routes, and perform implement-specific operations such as transporting product, towing equipment, or discharging material. The modular interface system enables autonomous control of hydraulic, electrical, and mechanical functions of the attached implement.

In one or more exemplary embodiments, the vehicle is configured to identify the type of implement coupled to the modular interface system and to automatically adjust operational parameters accordingly. Such parameters may include hydraulic pressure limits, flow rates, electrical power distribution, control logic, and safety constraints.

This implement-aware operation may be enabled through electrical connectors, sensors, or software identifiers associated with each implement, allowing the vehicle to optimize performance and safety for each attached implement.

In embodiments where the modular interface system is installed as part of a retrofit system, the existing agricultural vehicle may be configured to operate in one or more of the modes described above. The retrofit system enables integration of manual, semi-autonomous, or autonomous functionality without requiring redesign of the core vehicle drivetrain or chassis.

In such embodiments, the retrofit system may include additional sensors, control modules, or software configured to enable or enhance autonomous or semi-autonomous operation of the vehicle and attached implement.

The vehicle may allow selection of an operational mode through operator input, automated system logic, or remote command. Transition between modes may occur dynamically during operation, such as switching from manned mode to semi-autonomous mode during repetitive tasks.

Safety systems may be provided to ensure that mode transitions occur only under predetermined conditions.

The advantages of the invention include: reduced equipment redundancy, increased utilization of agricultural machinery, rapid implement changeover, compatibility with non-standard implements, and improved economic efficiency for agricultural operations. The invention is beneficial because it results in reduced input costs and higher return on investment through improved and continual productivity of the machine since the alternative would be to have a dedicated shuttle to be used during harvest and a dedicated tractor to be used for other non-harvest tasks.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the various embodiments of the present invention, it will be readily apparent to those skilled in the art that modifications may be made thereto which do not exceed the scope of the appended claims.

What is claimed is:

1. A multi-use agricultural vehicle, comprising:
a powered chassis including a front power unit and a rear interface region; and
a modular interface system mounted at the rear interface region, the modular interface system comprising:
a structural frame configured to transmit operational loads between the powered chassis and a selectively attachable implement;
one or more alignment features configured to guide the implement into a predetermined mounted position relative to the powered chassis;
a plurality of mechanical fasteners configured to secure the implement to the powered chassis after alignment;
wherein a hydraulic connection assembly is configured to operatively engage the vehicle to any of the selectively attachable implements.

2. The vehicle of claim 1 wherein the modular interface system is configured to selectively and operatively couple, each of: a bin carrier, a tug, a rear discharge, and a side dump.

3. The vehicle of claim 1 further comprising an electrical interface configured to provide electrical power and control communication between the powered chassis and the implement.

4. The vehicle of claim 1, wherein the alignment features include at least two laterally spaced alignment pins.

5. The vehicle of claim 1, wherein the plurality of mechanical fasteners includes at least twelve fasteners.

6. The vehicle of claim 1, wherein the hydraulic connection assembly comprises a hydraulic manifold including a plurality of ports.

7. The vehicle of claim 1, wherein the vehicle is operable in a manned mode and an autonomous mode.

8. The vehicle of claim 6, wherein the plurality of ports includes at least one of: a hi/low valve port, a load sense port, a pressure port, a return manifold port, a case drain port, a traction valve tee, or wheel motor ports.

9. The vehicle of claim 1, wherein the interface system enables the coupled implement to function as an integrated extension of the powered chassis.

10. A modular agricultural implement interface system, comprising:
a structural frame configured for attachment to a powered agricultural vehicle;
one or more alignment features configured to position an agricultural implement relative to the powered agricultural vehicle;
a plurality of mechanical fasteners configured to secure the agricultural implement to the powered agricultural vehicle;
wherein the interface system is configured to selectively couple the agricultural implement to the powered agricultural vehicle;
wherein the interface system includes a hydraulic connection assembly configured to operatively engage the vehicle to any of the selectively attachable implements.

11. The interface system of claim 10, wherein the agricultural implement is one of each of a bin carrier, a tug, a rear discharge, and a side dump.

12. The interface system of claim 10, wherein the alignment features include opposing alignment pins.

13. The interface system of claim 10, wherein the hydraulic connection assembly includes a hydraulic manifold having a plurality of hydraulic ports.

14. The interface system of claim 10, wherein the interface system is configured to be removably mounted to the powered agricultural vehicle.

15. The interface system of claim 10, wherein the interface system enables load-bearing integration of the agricultural implement with the powered agricultural vehicle.

16. A retrofit kit for converting an agricultural vehicle into a multi-implement vehicle, the retrofit kit comprising:
a modular interface system configured to be mounted to a rear portion of an existing agricultural vehicle, the modular interface system including:
a structural frame;
one or more alignment features;
a plurality of mechanical fasteners;
wherein the retrofit kit enables selective attachment of multiple agricultural implements including a bin carrier, a tug, a rear discharge, and a side dump; and
wherein the retrofit kit further includes a hydraulic connection assembly configured for hydraulic operation of the agricultural implement.

17. The retrofit kit of claim 16, wherein the hydraulic connection assembly includes a hydraulic manifold with multiple hydraulic ports.

18. The retrofit kit of claim 16, wherein the modular interface system is configured to mount to a vehicle frame not originally designed for multi-implement operation.

19. The retrofit kit of claim 16, wherein the retrofit kit enables year-round use of the agricultural vehicle for harvest and non-harvest operations.

20. A method of operating a multi-use agricultural vehicle, comprising:
aligning an agricultural implement with a modular interface system using one or more alignment features;
mechanically fastening the agricultural implement to the vehicle;
hydraulically coupling the agricultural implement to the vehicle; and
operating the vehicle with the agricultural implement as an integrated functional unit.
